(19) United States
(12) Patent Application Publication
(10) Pub. No.: US 2021/0148317 A1
(43) Pub. Date: May 20, 2021

(54) FUEL INJECTION VALVE

(71) Applicant: HITACHI AUTOMOTIVE SYSTEMS, LTD., Hitachinaka-shi, Ibaraki (JP)

(72) Inventors: Shigeo KUBA, Hitachinaka-shi, Ibaraki (JP); Akihiro YAMAZAKI, Hitachinaka-shi, Ibaraki (JP); Takahiro SAITO, Hitachinaka-shi, Ibaraki (JP); Masaki NAGAOKA, Hitachinaka-shi, Ibaraki (JP)

(73) Assignee: HITACHI AUTOMOTIVE SYSTEMS, LTD., Hitachinaka-shi, Ibaraki (JP)

(21) Appl. No.: 16/622,648

(22) PCT Filed: Mar. 26, 2018
(86) PCT No.: PCT/JP2018/011957

§ 371 Date: Dec. 13, 2019

(30) Foreign Application Priority Data
Jun. 16, 2017 (JP) 2017-118650

(51) Int. Cl. F02M 51/06; F02M 61/18

(52) U.S. Cl. CPC F02M 51/0696; F02M 61/1886

(57) ABSTRACT

Disclosed is a fuel injection valve in which a movable core and a fixed core are enclosed in a cylindrical body. The cylindrical body has an annular groove formed therein, on an outer circumferential side of a region in which the movable core and the fixed core are opposed to each other, to define a thin portion of small wall thickness. In a cross section taken along a center axis of the fuel injection valve, the thin portion has curved line sections on both end sides thereof in a direction along the center axis such that the curved line sections respectively connect a bottom of the annular groove to side edges of the annular groove by curved lines. The curved line sections are provided over a range of larger dimension, from the respective side edges in the direction along the center axis, than a depth dimension of the annular groove.

### FIELD OF THE INVENTION

The present invention relates to a fuel injection valve for injecting fuel.

### BACKGROUND ART

As a background art of the present technical field, there is known a fuel injection valve of the type disclosed in Japanese Laid-Open Patent Publication No. 2008-215362 (Patent Document 1). In the disclosed fuel injection valve, a magnetic cylindrical body is integrally formed from a metal pipe etc. such that the magnetic cylindrical body has a thin portion at a middle part thereof to magnetically insulate a valve body installation part and a core insertion part (see Abstract). This makes it possible to, during operation of an electromagnetic coil, prevent a magnetic field of the electromagnetic coil from being short-circuited by the magnetic cylindrical body and stably introduce the magnetic field to a space between an attraction part of a valve body and a core cylinder (see Abstract).

### PRIOR ART DOCUMENTS

### Patent Document

Patent Document 1: Japanese Laid-Open Patent Publication No. 2008-215362

### SUMMARY OF THE INVENTION

### Problem to be Solved by the Invention

In the fuel injection valve of Patent Document 1, the thin portion is provided to magnetically insulate the valve body installation part and the core (fixed core) insertion part of the magnetic cylindrical body (cylindrical member) as mentioned above. By the formation of such a thin portion, the magnetic field is stably introduced to the space between the attraction part (movable core) of the valve body and the core cylinder (fixed core) so as to increase a magnetic attraction force acting between the movable core and the fixed core. There is a case where the fixed core and other members such as a valve seat member with a valve seat are press-fitted in the cylindrical body. In this case, the cylindrical body is required to ensure a certain level of strength. From the viewpoint of ensuring the strength of the cylindrical body, there is a limit to reducing the thickness dimension (wall thickness) of the thin portion. In the fuel injection valve of Patent Document 1, sufficient consideration is not given to the shape of the thin portion so that the thickness dimension of the thin portion cannot be made so small. As a consequence, there is a limit to reducing a leakage flux flowing through the cylindrical body and increasing a magnetic attraction force acting on the movable core.

It is an object of the present invention to provide a fuel injection valve in which a thin portion of a cylindrical body is reduced in thickness dimension so as to increase a magnetic attraction force acting on a movable core.

### Means for Solving the Problems

To achieve the above objection, there is provided according to the present invention a fuel injection valve, comprising: a valve seat and a valve body that cooperatively open and close a fuel passage; a movable core and a fixed core that exert an electromagnetic force therebetween to drive the valve body; and a cylindrical body that encloses therein the movable core and the fixed core, wherein the cylindrical body has an annular groove formed therein, on an outer circumferential side of an opposed region where the movable core and the fixed core are opposed to each other, to define a thin portion of small wall thickness in a circumferential direction of the cylindrical body, wherein, in a cross section taken in parallel with a center axis of the fuel injection valve and including the center axis, the thin portion has curved line sections on both end sides thereof in a direction along the center axis such that the curved line sections respectively connect a bottom of the annular groove to side edges of the annular groove by curved lines, and wherein the curved line sections are provided over a range of larger dimension, from the respective side edges in the direction along the center axis, than a depth dimension of the annular groove.

### Effects of the Invention

According to the present invention, the thin portion of the cylindrical body is reduced in thickness dimension. With such thickness reduction of the thin portion, the magnetic attraction force acting on the movable core is increased. This leads to an increase of the set load of a spring member by which the valve body is biased, whereby the minimum fuel injection amount of the fuel injection valve is decreased.

### BRIEF DESCRIPTION OF DRAWINGS

FIG. 1 is a cross-sectional view of a fuel injection valve, taken along a valve axis (center axis) thereof, according to one embodiment of the present invention.

FIG. 2 is an enlarged cross-sectional view of the vicinity of a movable element 27 shown in FIG. 1.

FIG. 3 is an enlarged cross-sectional view of the vicinity of a nozzle part 8 shown in FIG. 2.

FIG. 4 is an enlarged cross-sectional view showing the configuration of a thin portion 5i according to one embodiment of the present invention.

FIG. 5 is a cross-sectional view showing a comparison in effect between the thin portion 5i of FIG. 4 and a comparative thin portion 5i′.

FIG. 6 is a schematic diagram showing a difference in valve body displacement (valve body lift) between the case where the thin portion 5i of FIG. 4 is used and the case where the comparative thin portion 5i′ is used.

FIG. 7 is an enlarged cross-sectional view showing the configuration of a thin portion 5i according to a modified example (first modified example) of the present invention.

FIG. 8 is an enlarged cross-sectional view showing the configuration of a thin portion according to another modified example (second modified example) of the present invention.

FIG. 9 is a cross-sectional view of an internal combustion engine to which the fuel injection valve 1 is mounted.

### DESCRIPTION OF EMBODIMENTS

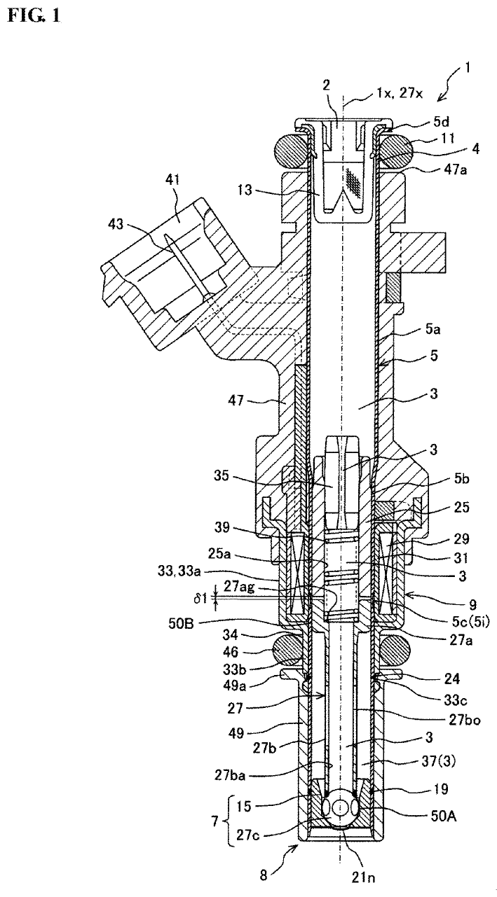

Hereinafter, an embodiment of the present invention will be described in detail below with reference to FIGS. 1 to 3.

The overall configuration of a fuel injection valve 1 will be first explained below with reference to FIG. 1. FIG. 1 is a cross-sectional view of the fuel injection valve, taken along a valve axis (center axis) thereof, according to one embodiment of the present invention. The center axis 1x is in agreement with an axis (valve body axis) 27x of a movable element 27 provided integrally with a valve body 27c, a rod part (connection part) 27b and a movable iron core 27a, and is in agreement with a center axis of a cylindrical body 5 and a center axis of a valve seat member 15.

In FIG. 1, an upper end part (upper end side) and a lower end part (lower end side) of the fuel injection valve 1 are sometimes referred to as a base end part (base end side) and a front end part (front end side), respectively. The expressions “base end part (base end side)” and “front end part (front end side)” are based on the mounting structure of the fuel injection valve 1 relative to a fuel flow direction or fuel pipe. In the present specification, the upper/lower positional relation of parts and portions of the fuel injection valve 1 is explained with respect to FIG. 1 and is not relevant to the vertical orientation in which the fuel injection valve 1 is mounted to an internal combustion engine.

In the fuel injection valve 1, the cylindrical body (cylindrical member) 5 is made of a metal material, and defines therein a fuel flow path (fuel passage) 3 substantially along the central axis 1x. The cylindrical body 5 is formed by press working such as deep drawing the metal material e.g. magnetic stainless steel into a stepped shape in a direction along the center axis 1x, and is thereby made larger in diameter at one end side (large diameter part 5a) thereof than at the other end side (small diameter part 5b) thereof.

A fuel supply port 2 is provided in a base end part of the cylindrical body 5. A fuel filter 13 is attached to the fuel supply port 2 to remove foreign substances mixed in fuel.

The base end part of the cylindrical body 5 has a collar portion (enlarged diameter portion) 5d formed by bending to be enlarged in diameter radially outwardly. There is an annular concave space (annular recess) 4 formed by the collar portion 5d and a base end side part 47a of a resin cover 47. An O-ring 11 is fitted in the annular concave space 4.

A valve part 7 with the valve body 27c and the valve seat member 15 is provided in a front end part of the cylindrical body 5. The valve seat member 15 is inserted in the front end part of the cylindrical body 5 and fixed by laser welding to the cylindrical body 5. The laser welding is performed on the entire circumference of the cylindrical body 5 from the outer circumferential side. The valve seat member 15 may be fixed by laser welding to the cylindrical body 5 after being press-fitted in the front end part of the cylindrical body 5.

A nozzle plate 21n is fixed to the valve seat member 15. Herein, the valve seat member 15 and the nozzle plate 21n constitute a nozzle part 8. The valve seat member 15 and the nozzle plate 21n are assembled together in the front end part of the cylindrical body 5 by being inserted and fixed into an inner circumferential surface of the cylindrical body 5.

In the present embodiment, the cylindrical body 5 is integrally formed in one piece throughout the length from the part in which the fuel injection port 2 is provided to the part in which the valve seat member 15 and the nozzle plate 21n are fixed. The front end part of the cylindrical body 5 serves as a nozzle holder to hold the nozzle part 8. In the present embodiment, the nozzle holder is formed integrally with the base end part of the cylindrical body 5.

A drive part 9 for driving the valve body 27c is disposed at a middle part of the cylindrical body 5. Herein, the drive part 9 is configured by an electromagnetic actuator (electromagnetic drive unit).

More specifically, the drive part 9 includes: a fixed iron core (fixed core) 25 fixed to the inside (inner circumferential side) of the cylindrical body 5; the movable element (movable member) 27 arranged inside the cylindrical body 5 on a front end side of the fixed iron core 25; an electromagnetic coil 29 fitted around the outer circumference of the cylindrical body 5; and a yoke 33 disposed on an outer circumferential side of the electromagnetic coil 29 and covering the electromagnetic coil 29. The movable element 27 has, at a base end side thereof, the movable iron core 27a opposed to and facing the fixed iron core 25 and arranged movably in the direction along the center axis 1x. The electromagnetic coil 29 is arranged on an outer circumferential side of (radially outward of) a region where the fixed iron core 25 and the movable iron core 27a are opposed to each other via a narrow gap δ1. In this arrangement, the movable iron core 27a and the fixed iron core 25 exert an electromagnetic force therebetween to drive the valve body 27c.

The movable element 27 and the fixed iron core 25 are installed in the cylindrical body 5. The cylindrical body 5 serves as a housing to surround and hold the movable iron core 27a and the fixed iron core 25 by being held in contact with the fixed iron core 25 and opposed to an outer circumferential surface of the movable iron core 27a. In other words, the cylindrical body 5 encloses therein the movable iron core 27a and the fixed iron core 25.

The movable iron core 27a, the fixed iron core 25 and the yoke 33 form a closed magnetic path through which a magnetic flux generated by energization of the electromagnetic coil 29 flows. The magnetic flux passes through the narrow gap 81. In order to reduce a leakage flux flowing through a part of the cylindrical body 5 corresponding in position to the narrow gap 81, the part of the cylindrical body 5 corresponding to the narrow gap 81 is configured as a non-magnetic part or a weak-magnetic part weaker in magnetism than the other parts of the cylindrical body 5. In the following explanation, the non-magnetic or weak-magnetic part is simply generically referred to as a non-magnetic part 5c.

In the present embodiment, the non-magnetic part Sc is constituted by forming an annular concave portion 5h in an outer circumferential surface of the cylindrical body 5. By the formation of the annular concave portion 5h, a portion of the cylindrical body 5 corresponding to the non-magnetic part 5c is made thin and thereby configured as a thin portion 5i. In other words, the thin portion 5i of small wall thickness is defined by the annular concave portion 5h circumferentially of the cylindrical body 5 on the outer circumferential side of the opposed region where the movable iron core 27a and the fixed iron core 25 are opposed to each other. The thin portion 5i is made smaller in wall thickness (thickness dimension) than the other parts and portions of the cylindrical body 5 so as to thereby increase the resistance of the magnetic flux to flow through the thin portion 5i. This makes it difficult for the magnetic flux to flow through the thin portion 5i. The configuration of the thin portion 5i will be explained in detail later.

The electromagnetic coil 29 is wound around a bobbin 31, which is made of a resin material in a cylindrical shape, and is fitted around the outer circumference of the cylindrical body 5. Further, the electromagnetic coil 29 is electrically connected to a terminal 43 of a connector 41. An external drive circuit (not shown) is connected to the connector 41 so as to supply a drive current to the electromagnetic coil 29 through the terminal 43.

The fixed iron core 25 is made of a magnetic metal material in a cylindrical shape, with a through hole 25a formed through the center thereof in the direction along the center axis 1x. The through hole 25a defines a fuel passage (upstream-side fuel passage) 3 on an upstream side of the movable iron core 27a. The fixed iron core 25 is press-fitted and fixed in a base end side of the small diameter part Sb of the cylindrical body 5 and located in the middle part of the cylindrical body 5. Since the large diameter part Sa is located on the base end side of the small diameter part 5b, it is easy to mount the fixed iron core 25. The fixed iron core 25 may be fixed to the cylindrical part 5 by welding or may be fixed to the cylindrical body 5 by combination of welding and press-fitting.

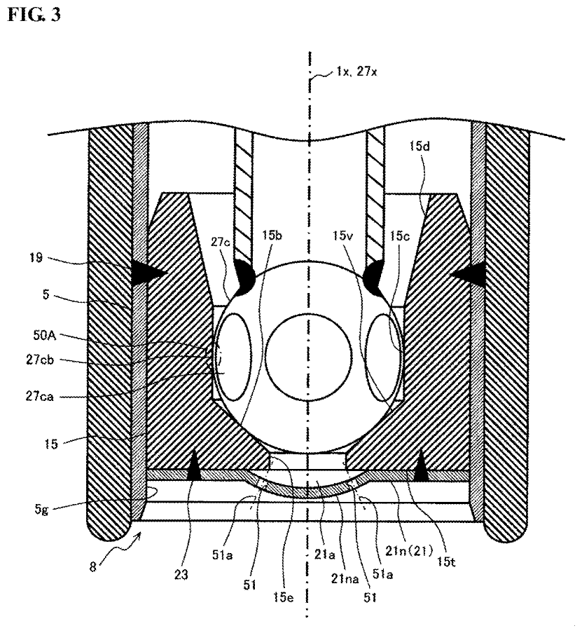

The movable element 27 is provided with the movable iron core 27a, the rod part (connection part) 27b and the valve body 27c as mentioned above. The movable iron core 27a is formed in an annular shape. The valve body 27c is contactable with a valve seat 15b (see FIG. 3) such that the valve seat 15b and the valve body 27c cooperatively open and close the fuel passage. The rod part 27b is formed in an elongated cylindrical shape and serves as a connection part to connect the movable iron core 27a and the valve body 27c to each other.

The movable iron core 27a is coupled to the valve body 27c so as to drive the valve body 27c in a valve opening/closing direction by the action of an electromagnetic attraction force exerted between the fixed iron core 25 and the movable iron core 27a.

Although the movable iron core 27a and the rod part 27b are fixed to each other in the present embodiment, the movable iron core 27a and the rod part 27b may be coupled displaceably relative to each other.

In the present embodiment, the rod part 27b and the valve body 27c are formed as separate pieces and fixed to each other. The fixing of the valve body 27c to the rod part 27b can be done by press-fitting or welding. Alternatively, the rod part 27b and the valve body 27c may be integrally formed in one piece.

The rod part 27b is circular cylindrical-shaped, with a hole 27ba formed therein in the direction of the axis and opened at an upper end of the rod part 27b to a lower end of the movable iron core 27. A communication hole (opening) 27bo is formed in the rod part 27b so as to allow communication between the inside (inner circumferential side) and outside (outer circumferential side) of the rod part 27b. There is a fuel chamber 37 provided between the outer circumferential surface of the rod part 27b and the inner circumferential surface of the cylindrical body 5.

A spring member is disposed in the through hole 25a of the fixed iron core 25. In the present embodiment, a coil spring 39 is used as the spring member. In the following explanation, the spring member is referred to as the coil spring 39.

One end of the coil spring 39 is in contact with a spring seat 27ag that is disposed inside the movable iron core 27a. The other end of the coil spring 39 is in contact with an adjuster (adjuster element) 35 that is disposed inside the through hole 25a of the fixed iron core 25. The coil spring 39 is arranged in a compressed state between the spring seat 27ag inside the movable iron core 27a and the lower end (front end side surface) of the adjuster (adjuster element) 35.

The coil spring 39 serves as a biasing member to bias the movable element 27 in a direction that brings the valve body 27c into contact with the valve seat 15b (i.e. valve closing direction). The biasing force applied to the movable element 27 (that is, the valve body 27c) by the coil spring 39 is controlled by adjusting the position of the adjuster 35 in the through hole 25a in the direction along the central axis 1x.

The fuel passage 3 is provided to pass through the center of the adjuster 35 in the direction along the center axis 1x.

The fuel supplied from the fuel supply port 2 flows through the fuel passage 3 inside the adjuster 35, flows through the fuel passage 3 in the front end side of the through hole 25a of the fixed iron core 25, and then, flows through the fuel passage 3 inside the movable element 27.

The yoke 33 is made of a magnetic metal material, and also serves as a housing of the fuel injection valve 1. The yoke 33 has a cylindrical stepped shape with a large diameter part 33a and a small diameter part 33b. The large diameter part 33a is cylindrical-shaped to cover the outer circumference of the electromagnetic coil 29. The small diameter part 38b is formed, with a diameter smaller than that of the large diameter part 33a, on a front end side of the large diameter part 33a. The small diameter part 33b is press-fitted or slipped onto the outer circumference of the small diameter part Sb of the cylindrical body 5 so that an inner circumferential surface of the small diameter part 33b is tightly held in contact with the outer circumferential surface of the cylindrical body 5. As at least a portion of the inner circumferential surface of the small diameter part 33b is opposed to and faces the outer circumferential surface of the movable iron core 27a via the cylindrical body 5, the magnetic resistance of the magnetic path in this opposed region is decreased.

An annular concave recess 33c is formed circumferentially in an outer circumferential surface of a front end side part of the yoke 33. The yoke 33 is joined, at a thin portion thereof on the bottom of the annular concave recess 33c to the cylindrical body 5 over the entire circumference by laser welding.

A cylindrical protector 49 with a flange portion 49a is slipped on the front end part of the cylindrical body 5 such that the front end part of the cylindrical body 5 is protected by the protector 49. The protector 49 is arranged to cover the laser weld portion 24 of the yoke 33.

There is an annular recess 34 formed by the flange portion 49a of the protector 49, the small diameter part 33b of the yoke 33 and the stepped surface between the large and small diameter parts 33a and 33b of the yoke 33. An O-ring 46 is fitted in the annular recess 34. The O-ring 46 serves as a seal to, when the fuel injection valve 1 is mounted to the internal combustion engine by insertion into an insertion hole of the internal combustion engine, secure liquid- and air-tightness between the inner circumferential surface of the insertion hole of the internal combustion engine and the outer circumferential surface of the small diameter part 33b of the yoke 33.

The resin cover 47 is formed by molding over the range from the middle part to the vicinity of the base end part of the fuel injection valve 1. Herein, a base end side portion of the large diameter part 33a of the yoke 33 is covered by a front end side part of the resin cover 47. The connector 41 is integrally formed of the same resin material as that of the resin cover 47.

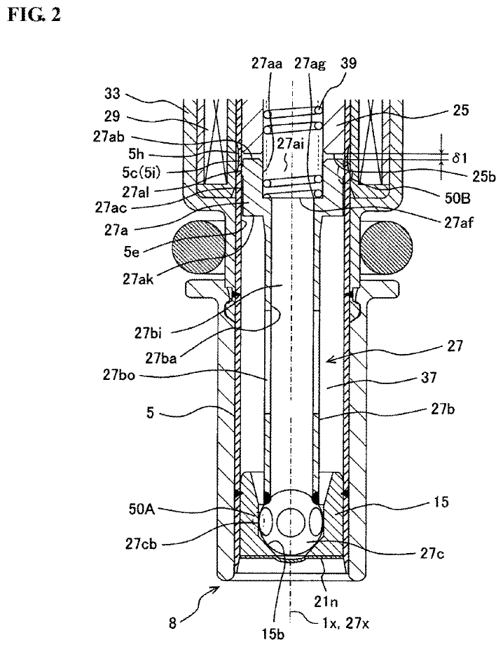

The configuration of the movable element 27 and its surroundings will be explained in more detail below with reference to FIG. 2. FIG. 2 is a cross-sectional view of the vicinity of the movable element 27 shown in FIG. 1.

In the present embodiment, the movable iron core 27a and the rod part 27b are integrally formed in one piece.

A recess portion 27aa is formed, in the center of an upper end surface (upper end part) 27ab of the movable iron core 27a, to be recessed toward the lower end side. A spring seat 27ag is located on the bottom of the recess portion 27aa so that one end (front end side portion) of the coil spring 39 is supported on the spring seat 27ag. Further, an opening 27ag is formed in the spring seat 27ag of the recess portion 27aa so as to communicate with the inside of the hole 27ba of the rod part 27b. The opening 27ag defines a fuel passage through which the fuel flowing into an inside space 27ai of the recess portion 27aa from the through hole 25a of the fixed iron core 25 is fed to an inside space 27bi of the hole 27ba of the rod part 27b.

Although the rod part 27b and the movable iron core 27a are formed in one piece in the present embodiment, the rod part 27b and the movable iron core 27a may alternatively be formed as separate pieces and fixed to each other.

The upper end surface (base end side surface) 27ab of the movable iron core 27 is located adjacent to the fixed iron core 25, and is opposed to and faces the lower end surface (front end side surface) 25b of the fixed iron core 25. An end surface of the movable iron core 27 opposite the upper end surface 27ab is directed to the front end side (nozzle side) of the fuel injection valve 1 and is hereinafter referred to as a lower end surface (lower end part) 27ak.

The upper end surface 27ab of the movable iron core 27a and the lower end surface 25b of the fixed iron core 25 serve as magnetic attraction surfaces between which the magnetic attraction force acts.

In the present embodiment, a sliding part is provided on the outer circumferential surface 27ac of the movable iron core 27a so as to slide over the inner circumferential surface 5e of the cylindrical body 5. As the sliding part, a radially outwardly protruding part 27al is formed on the outer circumferential surface 27ac. The inner circumferential surface Se serves as an upstream-side guide part 50B with which the protruding part 27al of the movable iron core 27a comes in sliding contact.

On the other hand, a guide surface 15c is provided on the valve seat member 15 such that a spherical surface 27cb of the valve body 27c comes in sliding contact with the guide surface 15c. This guide surface 15c serves as a downstream-side guide part 50A to guide the spherical surface 27cb. Accordingly, the movable element 27 is guided by two points, that is, the upstream-side guide part 50B and the downstream-side guide part 50A to reciprocate in the direction along the center axis 1x (valve opening/closing direction).

The opening (communication hole) 27bo is formed in the rod part 27 so as to allow communication between the inside (hole 27ba) and the outside (fuel chamber 37) as mentioned above. The communication hole 27bo defines a fuel passage through which the inside and outside of the rod part 27 communicate with each other. The fuel in the through hole 25a of the fixed iron core 25 is fed into the fuel chamber 37 through the hole 27ba and the communication hole 27bo.

Next, the configuration of the nozzle part 8 will be explained in more detail below with reference to FIG. 3. FIG. 3 is an enlarged cross-sectional view of the vicinity of the nozzle part 8 shown in FIG. 2.

A through hole (enlarged diameter part 15d, guide surface 15c, conical surface 15v, fuel introduction hole 15e) is formed through the valve seat member 15 in the direction along the central axis 1x. The conical surface (truncated conical surface) 15v, which has a diameter decreasing toward the downstream side, is located in the midway of the through hole. The valve seat 15b is located on the conical surface 15v. The opening/closing of the fuel passage is done by moving the valve body 27c into contact with or away from the valve seat 15b. The conical surface 15v with the valve seat Sb may occasionally be referred to as a valve seat surface.

The mutual contact part of the valve seat 15 and the valve body 27c serves as a seal part to seal out the fuel during the valve close state.

A part of the thought hole (enlarged diameter part 15d, guide surface 15c, conical surface 15v, fuel introduction hole 15e) located frontward of the conical surface 15v serves as a valve body installation hole to install therein the valve body 27c. The guide surface 15c is situated on an inner circumferential side of the valve body installation hole (enlarged diameter part 15d, guide surface 15c, conical surface 15v). As mentioned above, the guide surface 15c serves as one of the two guide parts to guide the movable element 27, that is, serves as the downstream-side guide part (downstream-side guide surface) 50A.

The enlarged diameter part 15d, which has a diameter decreasing toward the upstream side, is located on the upstream side of the guide surface 15c.

A lower end portion of the valve body installation hole (enlarged diameter part 15d, guide surface 15c, conical surface 15v) is connected to the fuel introduction hole 15e. The fuel introduction hole 1e is opened at a lower end thereof to a front end surface 15t of the valve seat member 15.

The nozzle plate 21n is attached to the front end surface 15t of the valve seat member 15 and fixed to the valve seat member 15 by a laser weld 23. The laser weld 23 is formed to surround the circumference of an injection hole formation region where fuel injection holes 51 are formed.

The nozzle plate 21n is made from a plate-shaped material (flat plate) of uniform thickness. An outwardly protruding part 21na is formed on the center of the nozzle plate 21n. Herein, the protruding part 21na is shaped into a curved surface (e.g. spherical surface). There is a fuel chamber 21 provided inside the protruding part 21na. The fuel chamber 21a is in communication with the fuel introduction hole 1e of the valve seat member 15 so that the fuel is fed into the fuel chamber 21a through the fuel introduction hole 15e.

A plurality of fuel injection holes 51 are formed in the protruding part 21na. The form of the fuel injection holes 51 is not particularly limited. Central axes 51a of these fuel injection holes may be in parallel with the central axis 1x of the fuel injection valve or may be inclined relative to the central axis 1x of the fuel injection valve. The protruding part 21na may not necessarily be formed.

The nozzle plate 21n is configured as a fuel injection element 21 that determines the form of fuel injection. The nozzle part 8 for fuel injection is constituted by the valve seat member 15 and the fuel injection element 21. The valve body 27c may be regarded as a structural member constituting the nozzle part 8.

In the present embodiment, a spherical ball valve body is used as the valve body 27c. On this account, a plurality of cut surfaces 27ca are formed on a portion of the valve body 27c facing the guide surface 15c at circumferential intervals to define a fuel passage for supply of the fuel to the valve seat part. The valve body 27c may be in the form of any valve body other than the ball valve body. For example, a needle valve body may be used.

The valve seat member 15 is fixed to the cylindrical body 5 by a weld 19 after being press-fitted into the inner circumferential surface 5g of the front end part of the cylindrical body 5.

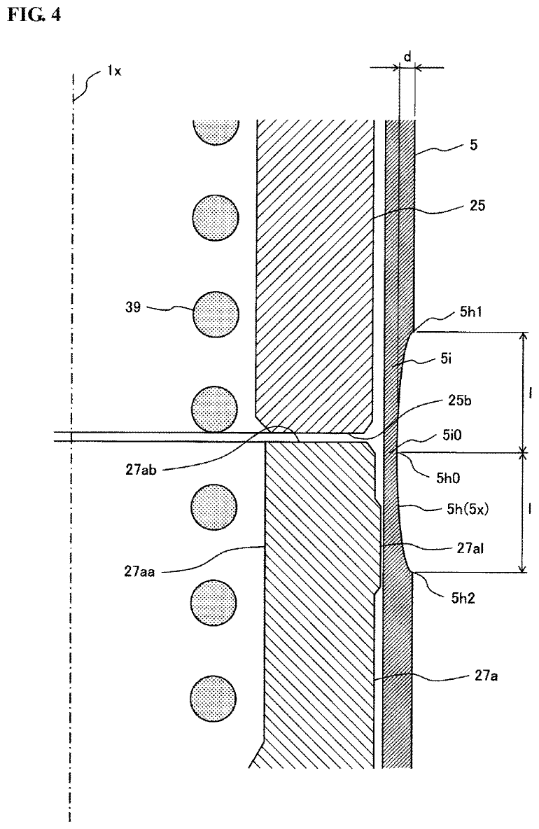

The configuration of the thin portion 5i will be now explained in detail below with reference to FIG. 4. FIG. 4 is a cross-sectional view showing the configuration of the thin portion 5i according to one embodiment of the present invention. In FIG. 4, the vicinity of the thin portion 5i is shown in enlargement.

In the present embodiment, the thin portion 5i is provided by forming the annular concave portion (annular groove) 5h so as to circle the outer circumferential surface of the cylindrical body 5 along the entire circumferential direction. In other words, the annular concave portion 5h is formed to define the thin portion 5i of small wall thickness circumferentially at an area of the cylindrical body 5 on the outer circumferential side of the opposed region where the movable iron core 27a and the fixed iron core 25 are opposed to each other (i.e., the upper end surface (base end side surface) of the movable iron core 27a and the lower end surface (front end side surface) of the fixed iron core 25 are opposed to each other).

The entire cross-sectional shape of the annular concave portion 5h taken in parallel with the center axis 1x and including the center axis 1x (hereinafter simply referred to as “cross-sectional shape”) is constituted by curved line sections 5x along a curve. In the present embodiment, the curved line sections 5x are shaped to form a curve that extends an arc of an ellipse (more specifically, a part of the circumference of an ellipse). Consequently, the cross-sectional shape of the annular concave portion 5h includes no bent section where straight lines intersect each other. The thin portion 5i is provided over the entire area from an upper side edge (base end side edge) 5h1 to a lower side edge (front end side edge) of the annular concave portion 5h, and has a thinnest site 5i0 of smallest wall thickness in the vicinity of the region where the fixed iron core 25 and the movable iron core 27a are opposed to each other. The annular concave portion 5h is the deepest at the thinnest site 5i0. Herein, a deepest part 5h0 of the annular concave portion 5h corresponding to the thinnest site 5i0 is regarded as a bottom of the annular concave portion 5h.

In the present embodiment, the thinnest site 5i0 is located at the center (midpoint) of the annular concave portion 5h in the width direction of the annular concave portion (i.e. the direction along the center axis 1x). A length dimension l from the side edge 5h1 to the thinnest site 5i0 in the direction along the center axis 1x is made larger than a depth dimension d of the annular concave portion 5h. A length dimension 1 from the side edge 5h2 to the thinnest site 5i0 (i.e. the bottom of the annular concave portion 5h) is also made larger than the depth dimension d of the annular concave portion 5h. In other words, the curved line section between 5h1 and 5i0 is provided over the area (range) of larger dimension 1 in the direction along the center axis 1x than the depth dimension d of the annular concave portion 5h; and the curved line section between 5h2 and 5i0 is provided over the area (range) of larger dimension l in the direction along the center axis 1x than the depth dimension d of the annular concave portion 5h.

The fixed iron core 25 is press-fitted in the cylindrical body 5 from the base end side, whereas the valve seat member 15 is press-fitted in the cylindrical body 5 from the front end side. For this reason, the cylindrical body 5 is required to have a strength capable of withstanding a compressive stress caused by the press-fitting. In particular, the thin portion 5i defined by the annular concave portion 5h tends to become low in strength. It is required that the thin portion 5i has a sufficient strength to withstand a compressive stress caused by the press-fitting.

In the present embodiment, the groove surface of the annular concave portion 5h from the upper and lower ends of the annular concave portion 5h to the thinnest site 5i0 (that is, the surface of the thin portion 5i) has a smoothly curved shape (curved line sections 5x) to be concave in shape when viewed from the outer circumferential side.

In other words, the groove surface between the upper and lower ends of the annular concave portion 5h (that is, the surface of the thin portion 5i) is smoothly curved into a concave shape (surface shape) when viewed from the outer circumferential side. With this configuration, the maximum compressive load carried by the annular concave portion 5h is increased so that the cylindrical body 5 is improved in strength.

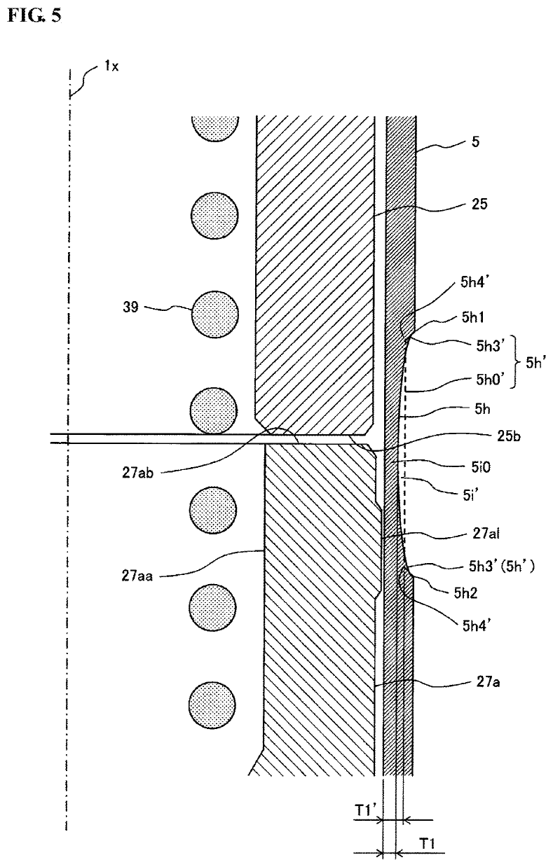

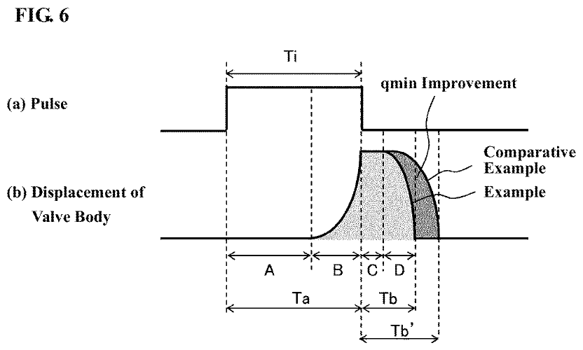

Next, the effects of the thin portion 5i of the present embodiment will be explained below with reference to FIGS. 5 and 6.

FIG. 5 is a cross-sectional view showing a comparison in effect between the thin portion 5i of FIG. 4 and a comparative thin portion 5i′.

In FIG. 5, a comparative annular concave portion (annular groove) 5h′ as a comparative example relative to the annular concave portion 5h of the present embodiment is shown by a broken line. The comparative annular concave portion 5h′ includes a bottom section 5h0′ at the center between upper and lower ends thereof and inclined sections (tapered sections) 5h3′ on upper and lower end sides of the bottom section 5h0′. There is hence defined a thin portion 5i′ having a wall thickness (thickness dimension) which is constant at a site over the bottom section 5h0′ of the annular concave portion 5h′ but increases from upper and lower ends of the bottom section 5h0′ toward side edges (upper and lower ends) 5h1 and 5h2 of the annular concave portion 5h′.

The comparative thin portion 5h′ has abrupt thickness change sections 5h4′ formed at sites where the bottom section 5h0′ and the inclined sections 5h3′ of the annular concave portion 5h′ intersect each other such that the wall thickness of the comparative thin portion 5′ abruptly changes at these sections 5h4′ due to bents in the outer circumferential surface. Since the maximum compressive load carried by the abrupt thickness change sections 45 becomes small, it is likely that breakages will occur in the abrupt thickness change sections 45 during the press-fitting of the fixed iron core 25 and the valve seat member 15.

In the present embodiment, by contrast, the cross-sectional shape of the annular concave portion 5h (that is, the outer circumferential surface of the thin portion 5i) is curved from the upper end to the lower end, whereby the maximum compressive load carried by the thin portion 5i is increased. The cylindrical body 5 is therefore improved in strength. It means that, in the case where the strength of the cylindrical body 5 is maintained at the same level as conventional, the minimum wall thickness T1 of the thin portion 5i can be made smaller than the wall thickness T1′ of the comparative example.

FIG. 6 is a schematic view showing a difference in valve body displacement (valve body lift) between the case where the thin portion 5i of FIG. 4 is used and the case where the comparative thin portion 5i′ is used.

In the present embodiment, the minimum wall thickness T1 of the thin portion 5i is made smaller than the wall thickness T1′ of the comparative thin portion so as to increase the magnetic resistance of the thin portion 5i and thereby reduce a leakage flux flowing through the cylindrical body 5 in the region where the fixed iron core 25 and the movable iron core 27a are opposed to the each other. Hence, the magnetic attraction force between the fixed iron core 25 and the movable iron core 27a is increased. As the magnetic attraction force becomes increased, the valve opening operation start timing of the valve body 27c can be advanced and, at the same time, the opening speed of the valve body 27c can be increased. This enables quick valve opening operation.

Further, the set load (biasing force) of the coil spring 39 can be increased as the magnetic attraction force becomes increased. With such increase in the set load of the coil spring, the valve closing operation start timing of the valve body 27c can be advanced and, at the same time, the closing speed of the valve body 27c can be increased. This enables quick valve closing operation. The valve closing operation will be explained in detail below.

FIG. 6 shows the valve body displacement during the execution of fuel injection by an injection pulse of pulse width (ON time) Ti. There exists a delay time period A until the valve body 27 starts its valve opening operation upon turn-on of the injection pulse. This is because it takes time for the magnetic attraction force between the fixed iron core 25 and the movable iron core 27a to become larger than the set load of the coil spring 39 and the pressure of the fuel. The valve body 27c changes from the valve close state into the valve open state during a time period B. The time elapsed from the turn-on of the injection pulse until the change of the valve body 27c into the valve open state is referred to as a valve opening time Ta.

In the present embodiment, the set load of the coil spring 39 is increased according to the increase of the magnetic attraction force so that the balance between the magnetic attraction force and the set load of the coil spring 28 is set to the same condition as that in the comparative example. Accordingly, the valve opening time Ta including the delay time period A elapsed until the start of the valve opening operation of the valve body 27c and the time period B required for the valve body 27c to change from the valve close state to the valve open state in the present embodiment is the same as that in the comparative example.

Upon turn-off of the injection pulse after the lapse of the ON time Ti, the magnetic attraction force between the fixed iron core 25 and the movable iron core 27a is decreased. It takes time until the magnetic attraction force is decreased. In the present embodiment, the valve body 27 starts its valve closing operation under the set load of the coil spring 39 after the lapse of a delay time period C. In the comparative example, on the other hand, the set load of the coil spring 39 is made smaller than that in the present embodiment so that the valve closing operation is started after the lapse of a time period longer than the delay time period C. Thus, the delay time period elapsed until the start of the valve closing operation is made shorter in the present embodiment than in the comparative example.

As the set load of the coil spring 39 is made larger in the present embodiment than that in the comparative example, the closing speed of the valve body 27c becomes higher in the present embodiment than that in the comparative example so that the valve body 27 changes from the valve open state to the valve close state during a time period D shorter than that in the comparative example. Thus, the time period required for the valve body to change from the valve open state to the valve close state is made shorter in the present embodiment than in the comparative example.

Accordingly, the valve closing time Tb including the delay time period C elapsed until the start of the valve closing operation of the valve body 27c and the time period D required for the valve body 27c to change from the valve open state to the valve close state is made shorter in the present embodiment than the valve closing time Tb′ in the comparative example.

In the present embodiment, the controllable minimum fuel injection amount (qmin) is decreased with shortening of the valve closing time Tb. It is therefore possible to improve the qmin performance of the fuel injection valve. The present inventors have confirmed by simulation tests that the adoption of the above embodiment allows a decrease in the minimum thickness of the thin portion 5i while maintaining the strength of the cylindrical body 5 at the same level as that of the comparative example and leads to a 10% improvement in the qmin performance relative to that of the comparative example.

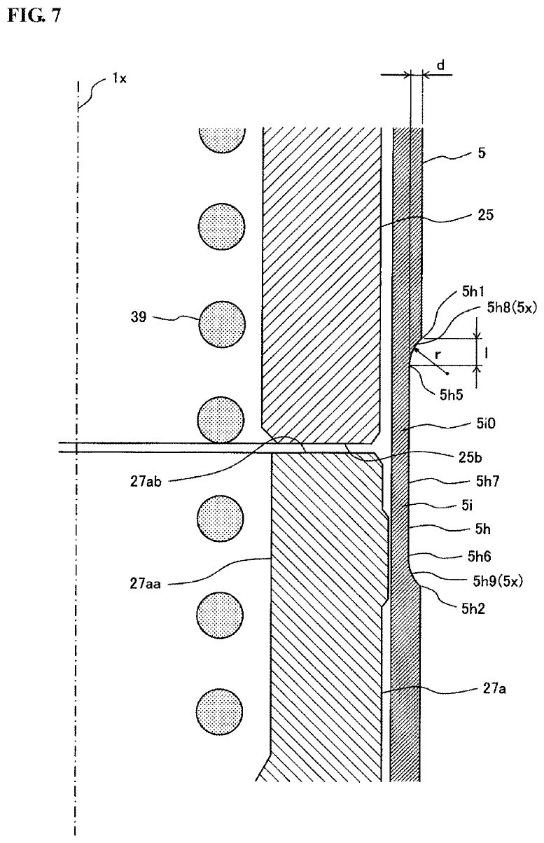

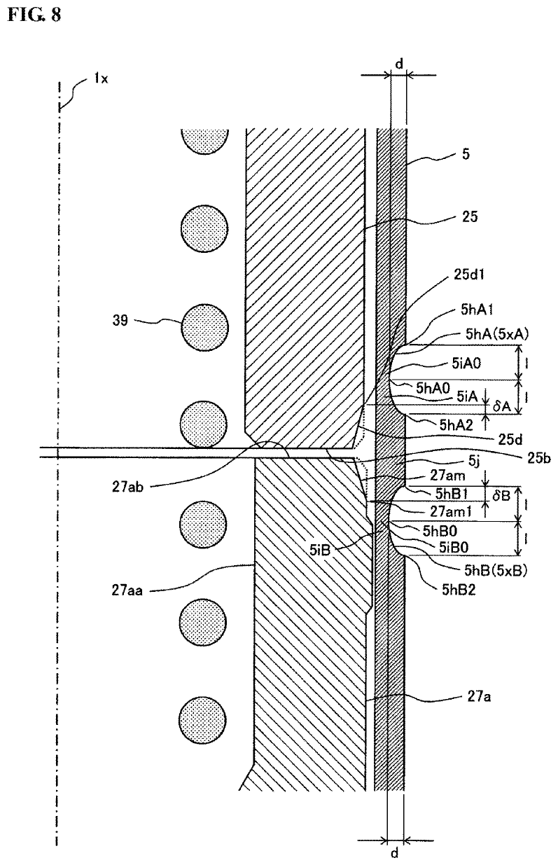

Modified examples of the thin portion 5i will be explained below with reference to FIGS. 7 and 8.

FIG. 7 is a cross-sectional view of the thin portion 5i according to one modified example (first modified example) of the present invention. In FIG. 7, the vicinity of the thin portion 5i is shown in enlargement.

In the first modified example, the annular concave portion 5h includes a recess section 5h7 formed with a depth dimension d (constant depth) between points 5h5 and 5h6. A groove surface of the annular concave portion 5h from the point 5h5 to a side edge (upper end) 5h1 of the annular concave portion in the direction along the center axis 1x and a groove surface of the annular concave portion 5h from the point 5h6 to a side edge (lower end) of the annular concave portion in the width direction are both smoothly curved to be concave in shape (surface shape) when viewed from the outer circumferential side. In other words, the cross-sectional shape of the groove surface 5h8 between 5h1 and 5h5 is constituted by a curved line section (curve) 5x passing through 5h1 and 5h5; and the cross-sectional shape of the groove surface 5h9 between 5h2 and 5h6 is constituted by a curved line section (curve) 5x passing through 5h2 and 5h6. More specifically, when viewed in cross section, the groove surface 5h8 between 5h1 and 5h5 is shaped to extend along an arc passing through 5h1 and 5h5; and the groove surface 5h9 between 5h2 and 5h6 is shaped to extend along an arc passing through 5h1 and 5h5.

A length dimension l between Shi and 5h5 in the direction along the center axis 1x is made larger than the depth dimension d of the annular concave portion 5h. In other words, each of the curved line sections 5x between 5h1 and 5h5 and between 5h2 and 5h6 is provided over the area (range) of larger dimension l from the side edge 5h1, 5h2 in the direction along the center axis 1x than the depth dimension d of the annular concave portion 5h.

In the first modified example, the length dimension l between 5h2 and 5h6 in the direction along the center axis 1x is equal to the length dimension l between 5h1 and 5h5. The length dimension l between 5h2 and 5h6 may however be different from the length dimension l between 5h1 and 5h5 as long as the length dimension l is larger than the depth dimension d of the annular concave portion 5h.

In the case where the groove surface 5h8, 5h9 is arc-shaped in cross section as in the first modified example, the radius r of the arc is made larger than the depth dimension d of the annular concave portion 5h.

It is possible in the first modified example to obtain the same effects as those in the above-mentioned embodiment by setting the depth dimension d of the annular concave portion 5h and the set load of the coil spring 39 to the same conditions as those in the above-mentioned embodiment. In the first modified example, the maximum compression load carried by the thin portion 5i is smaller than that in the above-mentioned embodiment, but is larger than that in the comparative example.

FIG. 8 is a cross-sectional view of the thin portion 5i according to another modified example (second modified example) of the present invention. In FIG. 8, the vicinity of the thin portion 5i is shown in enlargement.

In the second modified example, a first annular concave portion (first annular groove) 5hA and a second annular concave portion (second annular groove) 5hB are provided on the cylindrical body at positions apart from each other in the direction along the center axis 1x. The first annular concave portion 5hA is formed to define a first thin portion 5iA on the cylindrical body 5, whereas the second annular concave portion 5hB is formed to define a second thin portion 5iB on the cylindrical body 5. There is provided a thick portion 5j of larger wall thickness between the first annular concave portion 5hA and the second annular concave portion 5hB.

In the second modified example, a thinnest site 5iA of the first thin portion 5iA is located at the center (midpoint) of the first annular concave portion 5hA in the width direction (i.e. the direction along the center axis 1x); and a thinnest site 5iB0 of the second thin portion 5iB is located at the center (midpoint) of the second annular concave portion 5hB in the width direction (i.e. the direction along the center axis 1x).

The first annular concave portion 5hA is the deepest at the thinnest site 5iA0 of the first thin portion 5iA. A deepest part 5hA0 of the first annular concave portion 5hA corresponding to the thinnest site 5iA0 is regarded as a bottom of the first annular concave portion 5hA. Further, the second annular concave portion 5hB is the deepest at the thinnest site 5iB0 of the second thin portion 5iB. A deepest part 5hB0 of the second annular concave portion 5hB corresponding to the thinnest site 5iB0 is regarded as a bottom of the second annular concave portion 5hB.

A length dimension l from one side edge 5hA1 of the first annular concave portion 5hA to the thinnest site 5iA0 in the direction along the center axis 1x is made larger than a depth dimension d of the first annular concave portion 5hA. A length dimension l from the other side edge 5hA2 of the first annular concave portion 5hA to the thinnest site 5iA0 in the direction along the center axis 1x is also made larger than the depth dimension d of the first annular concave portion 5hA. In other words, the first annular concave portion 5hA includes: a curved line section 5xA provided between 5hA1 and 5iA0 over the area (range) of larger dimension l from the side edge 5hA1 in the direction along the center axis 1x than the depth dimension d of the first annular concave portion 5hA; and a curved line section 5xA provided between 5hA2 and 5iA0 over the area (range) of larger dimension l from the side edge 5hA2 in the direction along the center axis 1x than the depth dimension d of the first annular concave portion 5hA. In the second modified example, the curved line section 5xA between 5hA1 and 5iA0 and the curved line section 5xA between 5hA2 and 5iA0 are shaped to extend along arcs of one ellipse.

A length dimension 1 from one side edge 5hB1 of the second annular concave portion 5hB to the thinnest site 5iB0 in the direction along the center axis 1x is made larger than a depth dimension d of the second annular concave portion 5hB. A length dimension l from the other side edge 5hB2 of the second annular concave portion 5hB to the thinnest site 5iB0 in the direction along the center axis 1x is also made larger than the depth dimension d of the second annular concave portion 5hB. In other words, the second annular concave portion 5hB includes: a curved line section 5xB provided between 5hB1 and 5iB0 over the area (range) of larger dimension l from the side edge 5hB1 in the direction along the center axis 1x than the depth dimension d of the second annular concave portion 5hB; and a curved line section 5xB provided between 5hB2 and 5iB0 over the area (range) of larger dimension l from the side edge 5hB2 in the direction along the center axis 1x than the depth dimension d of the second annular concave portion 5hB. In the second modified example, the curved line section 5xB between 5hB1 and 5iB0 and the curved line section 5xB between 5hB2 and 5iB0 are shaped to extend along arcs of one ellipse.

Since the thick portion 5j is situated on the outer circumferential side of the opposed region where the fixed iron core 25 and the movable iron core 27a are opposed to each other, a part of the magnetic flux that should flow through the lower end surface 35b of the fixed iron core 25 and the upper end surface 27ab of the movable iron core 27a (that is, a leakage flux) leaks from a side surface of the fixed iron core 25 to a side surface of the movable iron core 27a (and vice versa) through the thick portion 5j. For reduction of such a leakage flux, a clearance widening portion is provided on at least either one of the side surfaces (outer circumferential surfaces) of the movable and fixed iron cores 27a and 25 at a position opposed to the inner circumferential surface of the thick portion 5j so as to widen a clearance between the inner circumferential surface of the thick portion 5j and the side surface of the core.

In the second modified example, clearance widening portions 25d and 27am are respectively formed on the side surfaces of the movable and fixed iron cores 27a and 25 at positions opposed to the thick portion 5j so as to widen a clearance between the inner circumferential surface of the cylindrical body 5 and the side surface of the core 27a, 25. The formation of at least either one of the clearance widening portions 25d and 27am leads to an increase of the magnetic resistance against the leakage flux flowing from the side surface of the fixed iron core 25 to the side surface of the movable iron core 27a (and vice versa) through the thick portion 5i, whereby the leakage flux is unlikely to flow. The magnetic resistance against the leakage flux is more increased by forming both of the clearance widening portions 25d and 27am.

In the second modified example, the clearance widening portions 25d and 27am constituted by tapered surfaces. More specifically, each of the clearance widening portions 25d and 27am has a cross-sectional shape defined by a straight line inclined relative to the center axis 1x. This straight line extends such that the straight line gets closer to the center axis 1x (i.e. the clearance between the outer circumferential surface of the core and the inner circumferential surface of the cylindrical body 5 becomes smaller) as the distance to the opposed region of the fixed iron core 25 and the movable iron core 27a decreases and such that the straight line gets away from the center axis 1x (i.e. the clearance between the outer circumferential surface of the core and the inner circumferential surface f the cylindrical body 5 becomes larger) as the distance to the base end or front end of the core decreases. In other words, the clearance widening portions 25d and 27am are formed such that the fixed iron core 25 and the movable iron core 27a become smaller in diameter as they get closer to the opposed region.

Further, a base end side edge 25d1 of the clearance widening portion 25d is situated at a position closer to the base end side than the side edge (front end side edge) 5hA2 of the first annular concave portion 5hA in the direction along the center axis 1x; and a front end side edge 25am1 of the clearance widening portion 27am is situated at a position closer to the front end side than the side edge (base end side edge) 5hB1 of the second annular concave portion 5hB.

It is possible in the second modified example to obtain the same effects as those in the above-mentioned embodiment by setting the depth dimension d of the first and second annular concave portions 5hA and 5hB and the set load of the coil spring 39 to the same conditions as those in the above-mentioned embodiment.

The number of annular concave portions may be three or more.

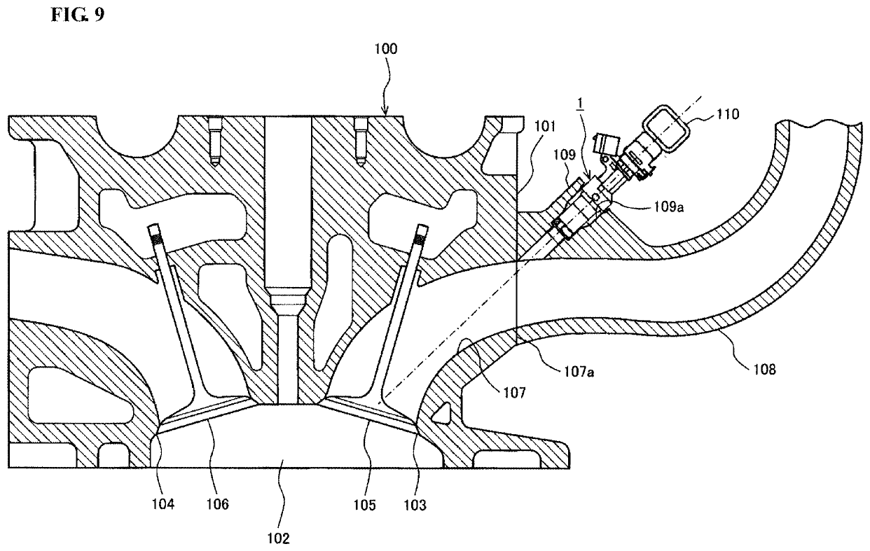

An internal combustion engine to which the fuel injection valve according to the above embodiment of the present invention is mounted will be explained below with reference to FIG. 9. FIG. 7 is a cross-sectional view of the internal combustion engine to which the fuel injection valve 1 is mounted.

A cylinder 102 is formed in an engine block 101 of the internal combustion engine 100. An intake port 103 and an exhaust port 104 are provided on the top of the cylinder 102. An intake valve 105 is disposed in the intake port 103 so as to open or close the intake port 103, whereas an exhaust valve 106 is disposed in the exhaust port 104 so as to open or close the exhaust port 104. Further, an intake passage 107 is formed in the engine block 101 in communication with the intake port 103. An intake pipe 108 is connected to an inlet-side end portion 107a of the intake passage 107.

A fuel pipe 110 is connected to the fuel supply port 2 of the fuel injection valve 1 (see FIG. 1).

An attachment portion 109 for attachment of the fuel injection valve 1 is provided on the intake pipe 108. An insertion hole 109a is formed in the attachment portion 109 such that the fuel injection valve 1 is inserted in the insertion hole 109a. Since the insertion hole 109a penetrates to an inner wall surface of the intake pipe 108 (intake passage), the fuel injected from the fuel injection valve 1 in the insertion hole 109a is fed into the intake passage. In the case where the fuel injection valve is of two-directional spray type, two intake ports 103 are provided on the engine block 101; and fuel sprays are injected from the fuel injection valve toward the respective intake ports 103 (intake valves 105).

In the fuel injection valve 1 according to the above embodiment of the present invention, the thin portion 5i of the cylindrical body 5 is made smaller in wall thickness (thickness dimension). This leads to a reduction of the leakage flux that flows through the thin portion 5 and does not flow through the opposed ends of the fixed iron core 25 and the movable iron core 27a, thereby increasing the magnetic attraction force exerted on the movable iron core 27a.

With increase of the magnetic attraction force, the set load of the coil spring (spring member) 39 can be increased so as to advance the valve closing operation start timing of the valve body 27c and increase the closing speed of the valve body 27c for quick valve closing operation of the valve body 27.

As the time required for valve closing operation of the valve body 27 is shortened, the controllable minimum fuel injection amount (qmin) is decreased to allow an improvement in the qmin performance of the fuel injection valve. As a result, the fuel efficiency performance of the internal combustion engine is improved.

The cylindrical body 5 with the thin portion 5i according to the above embodiment of the present invention is effective to ensure the sufficient strength to withstand the press-fitting of the fixed iron core 25 and the valve seat member 15. Even in the case where either one or both of the fixed iron core 25 and the valve seat member 15 are not press-fitted in the cylindrical body 5, the strength of the cylindrical body 5 is improved to increase the reliability of the fuel injection valve 1.

It is preferable that the annular concave portion (annular groove) 5h by which the thin portion 5i is defined is formed in a continuous annular shape so as to circle the outer circumferential surface of the cylindrical body 5 in the circumferential direction. The annular concave portion 5h may alternatively be formed in a discontinuous shape with a plurality of divided concave zones although the effect of reducing the leakage flux flowing through the cylindrical body 5 becomes small.

It should be understood that the present invention is not limited to the above-mentioned embodiment and examples. It is feasible to eliminate a part of the features of the above embodiment or example or feasible to add any unmentioned feature to the above embodiment or example.

For example, the following aspects of the present invention are possible in the light of the above-mentioned embodiments.

According to one aspect of the present invention, there is provided a fuel injection valve, comprising: a valve seat and a valve body that cooperatively open and close a fuel passage; a movable core and a fixed core that exert an electromagnetic force therebetween to drive the valve body; and a cylindrical body that encloses therein the movable core and the fixed core, wherein the cylindrical body has an annular groove formed therein, on an outer circumferential side of an opposed region where the movable core and the fixed core are opposed to each other, to define a thin portion of small wall thickness in a circumferential direction of the cylindrical body, wherein, in a cross section taken in parallel with a center axis of the fuel injection valve and including the center axis, the thin portion has curved line sections on both end sides thereof in a direction along the center axis such that the curved line sections respectively connect a bottom of the annular groove to side edges of the annular groove by curved lines, and wherein the curved line sections are provided over a range of larger dimension, from the respective side edges in the direction along the center axis, than a depth dimension of the annular groove.

According to a preferable aspect of the present invention, there is provided a fuel injection valve as described above, wherein, in the cross section, the curved line sections of the thin portion are shaped to form a curve that connects one of the side edges of the annular groove and the other side edge of the annular groove in the direction along the center axis.

In another preferable aspect of the present invention, there is provided a fuel injection valve as described above, wherein the curve formed by the curved line sections of the thin portion is in the shape of an arc of an ellipse.

In still another preferable aspect of the present invention, there is provided a fuel injection valve as described above, wherein the thin portion includes first and second thin portions located apart from each other in the direction along the center axis and respectively defined by first and second annular grooves.

In yet another preferable aspect of the present invention, there is provided a fuel injection valve as described above, wherein the cylindrical body includes a thick portion located between the first and second thin portions and having a wall thickness larger than those of the first and second thin portions, and wherein at least one of the movable and fixed cores has a clearance widening portion formed on an outer circumferential surface thereof at a position opposed to an inner circumferential surface of the thick portion so as to widen a clearance between the inner circumferential surface of the thick portion and the outer circumferential surface of the at least one of the movable and fixed cores.

1. A fuel injection valve, comprising:
a valve seat and a valve body that cooperatively open and close a fuel passage;
a movable core and a fixed core that exert an electromagnetic force therebetween to drive the valve body; and
a cylindrical body that encloses therein the movable core and the fixed core,
wherein the cylindrical body has an annular groove formed therein, on an outer circumferential side of an opposed region where the movable core and the fixed core are opposed to each other, to define a thin portion of small wall thickness in a circumferential direction of the cylindrical body,
wherein, in a cross section taken in parallel with a center axis of the fuel injection valve and including the center axis, the thin portion has curved line sections on both end sides thereof in a direction along the center axis such that the curved line sections respectively connect a bottom of the annular groove to side edges of the annular groove by curved lines, and
wherein the curved line sections are provided over a range of larger dimension, from the respective side edges in the direction along the center axis, than a depth dimension of the annular groove.

2. The fuel injection valve according to claim 1,
wherein, in the cross section, the curved line sections of the thin portion are shaped to form a curve that connects one of the side edges of the annular groove and the other of the side edges of the annular groove in the direction along the center axis

3. The fuel injection valve according to claim 2,
wherein the curve formed by the curved line sections of the thin portion is in the shape of an arc of an ellipse.

4. The fuel injection valve according to claim 2,
wherein the thin portion includes first and second thin portions located apart from each other in the direction along the center axis and respectively defined by first and second annular grooves.

5. The fuel injection valve according to claim 4,
wherein the cylindrical body includes a thick portion located between the first and second thin portions and having a wall thickness larger than those of the first and second thin portions, and
wherein at least one of the movable and fixed cores has a clearance widening portion formed on an outer circumferential surface thereof at a position opposed to an inner circumferential surface of the thick portion so as to widen a clearance between the inner circumferential surface of the thick portion and the outer circumferential surface of the at least one of the movable and fixed cores.
